(19) United States
(12) Patent Application Publication
(10) Pub. No.: US 2002/0100560 A1
(43) Pub. Date: Aug. 1, 2002

(54) Wallpaper hanging device

(76) Inventor: Joseph Mekrut, Ballground, GA (US)

Correspondence Address: William B. Noll, 402 Anemone Street, Panama City Beach, FL, 32413, US

(21) Appl. No.: 09/773,082

(22) Filed: Feb. 1, 2001

(51) Int. Cl. B32B 31/00

(52) U.S. Cl. 156/574; 156/579

(57) ABSTRACT

A wallpaper hanging device for applying a tangential wiping force to fresh wallpaper, where the device comprises a thin, flexible, curved body portion having a pair of parallel wiping edges, and a pair of curved shorter edges extending therebetween. The body portion may include a central embossed portion for stabilizing the device, and provide a convenient location for identifying logos, etc.

### FIELD OF THE INVENTION

This invention is directed to the field of wallpaper hanging tools, more particularly to a device to assist a user thereof in evenly distributing the paper's fluid adhesive and eliminating air bubbles and pockets during the paper hanging process.

### BACKGROUND OF THE INVENTION

The present invention relates to a bowed or arcuate shaped hand tool for leveling fresh wallpaper placed on a wall, where it is critical to ensure the adhesion and placement of the wallpaper. Typically, whether wallpaper is prepasted or has glue applied thereto, it must be quickly placed on the receiving wall and evenly wiped to position the wallpaper. The wiping can be accomplished by a variety of devices, most typically a rigid, hand held plastic device whose edge is held against the wallpaper and moved toward the paper's edge to remove excessive glue, and to remove trapped air bubbles. One concern that faces the person hanging the paper is to be careful in wiping the paper so as to not tear the limp and moist paper. Another concern is the alignment and pattern matching of the wallpaper, all this coupled with removal of excessive glue and air bubbles. As a consequence, an effective tool was needed to accomplish the desired tasks.

The prior art offers a number of wallpaper hanging aids to assist a user in positioning and hanging wallpaper. Several of these aids may be found in the following U.S. Patents:

a.) U.S. Pat. No. 5,445,704, to Dizon, teaches a wallpaper applicator comprising a handle portion with a gripping portion, a first frame member and a second frame member. The gripping portion, first frame member and second frame member are arranged in an “I” configuration. The first frame member has a trimmer guide and a clip pivotally mounted and biased in a closed condition for releasably retaining an end of a strip of wallpaper. The second frame member has frame extensions and a guide rod rotatably mounted at a remote end thereof. Two parallel foam cushioned rollers are rotatably mounted on the handle for rolling along a wall. The first frame member rotatably engages a first roller and the second frame member rotatably engages a second roller. The trimmer guide has a straight edge extending substantially parallel to the cushioned rollers. The wallpaper applicator pivots about one of the cushioned rollers for applying the trimmer guide to a corner between a ceiling and wall. Wallpaper is threadable over the guide rod, about the cushioned rollers, about the trimmer guide and releasably retained by the retainer means for applying wallpaper to the corner. Upon releasing the wallpaper, the applicator is rolled along applying the wallpaper to the wall.

b.) U.S. Pat. No. 4,490,198, to Mitchell, relates to a wallpaper hanging tool constructed to include a guide plate assembly having a pair of paper clamps on one side, and having an elongated edge as a guide edge over which paper is drawn and then clamped. The handle is centrally attached to the guide plate assembly, and paper held by the clamps is positioned at the ceiling edge of a wall, then cut at the ceiling edge and smoothed downward.

c.) U.S. Pat. No. 4,711,682, to Barbe et al., is directed to a wallpaper applicator for single-handedly applying on a flat surface and in a single continuous stroke the sticky face of a wallpaper. The applicator is characterized in that it eliminates distortion of the wallpaper and formation of air bubbles in between the wallpaper and the applied surface. The device comprises an elongated cross-sectionally polygonal casing in which lies a web of wallpaper; the latter is biased against two of the flat side walls of the casing by a weight rod engaged in the cylindrical hollow defined by the wallpaper web. One casing flat side wall defines a longitudinal slot through which escapes the leading edge portion of the wallpaper.

d.) U.S. Pat. No. D-428,315, to Baker, discloses a wallpaper applicator that features a planar blade having a circular hold handle along one edge of the planar blade.

e.) U.S. Pat. No. D-426,758, to Mitchell, illustrates a wallpaper hanging tool that is characterized by a rigid planar blade member that includes a tapered applicator edge.

f.) U.S. Pat. No. D-297,801, to Olsson, teaches a wallpaper hanging tool that is stepped from a broad face to a narrow face, where the broad face may include a serrated face.

None of the above cited references teach an effective device to wipe fresh wallpaper by the use of a device that tangentially moves across the surface of the wallpaper to protect the paper from tears and other damage to the paper. The manner by which the present invention accomplishes this unique ability of the device will become apparent in the description which follows.

### SUMMARY OF THE INVENTION

The present invention relates to a hand held, wallpaper application device for use in hanging, positioning and aligning fresh wallpaper to a flat wall. The device comprises a curved, bowed or arcuate shaped member that features a thin, preferably plastic body, having a pair of parallel wiping edges joined together by two curved edges. By the curved shape of the body member the user may wipe across the wallpaper surface to squeeze excessive paste or glue from under the wallpaper, where the wiping edge is positioned substantially tangentially to the paper surface. This allows for the effective removal of paste, elimination of air bubbles, and minimizes tearing of the moist and limp wallpaper.

Accordingly, an object of this invention is to provide an effective tool for the ready removal of excessive paste or glue, while eliminating air bubbles, and minimizing the risk of tearing the wallpaper.

Another object hereof is the provision of a hand held, arcuate shaped tool that can be wiped across the moist and limp wallpaper, where the wiping edge of the tool moves substantially tangentially over the wallpaper.

These and other objects of the invention will become more apparent in the further description which follows, particularly when read in conjunction with the accompanying drawings.

### BRIEF DESCRIPTION OF DRAWINGS

FIG. 1 is a perspective view of the wallpaper hanging device according to the present invention.

FIG. 2 is a perspective view illustrating the use of the device hereof as it may be used in applying the wallpaper to a wall.

FIG. 3 is a second perspective view of the device of this invention, showing further the curvature relationship of the device.

### DETAILED DESCRIPTION OF PREFERRED EMBODIMENT

The invention hereof is directed to a wallpaper applicator of the type to be held in the user's hand to wipe across the wallpaper to remove excess paste or glue, and to eliminate air bubbles, while minimizing damage to the fresh wallpaper. The invention will now be described with regard to the several Figures, where like reference numerals represent like components or features throughout the several views.

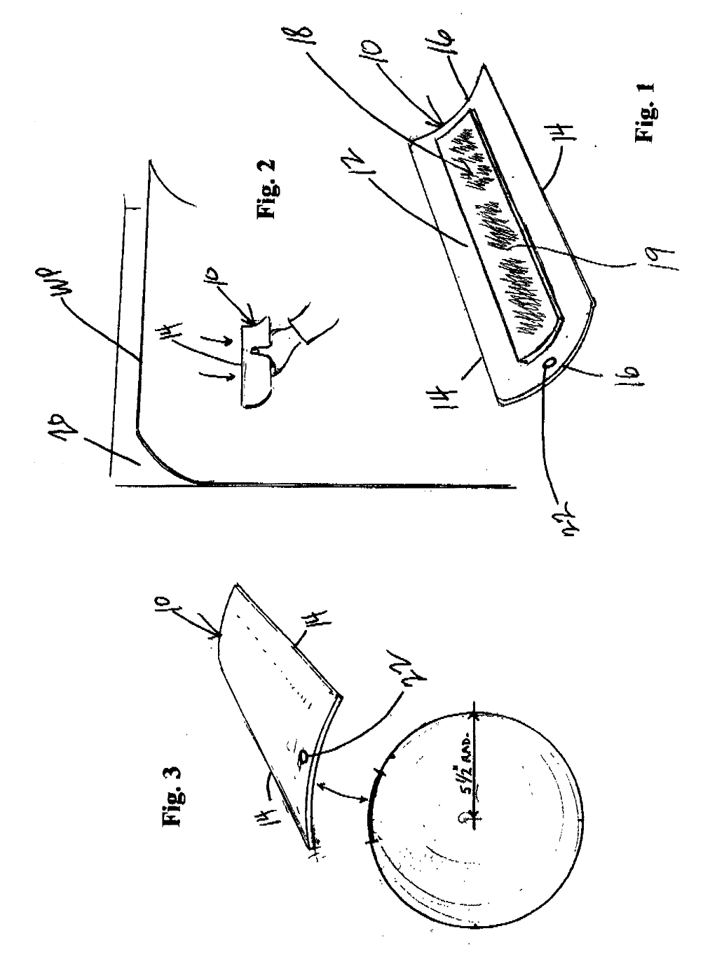

Tuning now to the different Figures, the device 10 of this invention comprises a thin body portion 12, such as formed of polyurethane, having a pair of parallel wiping, rounded edges 14, where a preferred length is about ten inches, and a pair of curved side edges 16 having a preferred length of about four inches. The curved, bowed or arcuate body portion 12 has an approximate radius of about 5½ inches, see FIG. 3. Within the respective edges there may be an embossed secon 18, as best seen in FIG. 1, to provide some strength and stability to the device. Further, the embossed section 18 may include an upper surface 19 modified by an enhanced gripping surface to help in using and holding the device.

FIG. 2 illustrates the use of the device 10 to apply wallpaper (WP) to a supporting wall 20, where, by the curved nature of the body portion 12, the user is actually applying a tangential force to the wiping action. This not only is a convenient way to remove excess adhesive and air bubbles, it helps to assure against damage, such as tearing, to the moist and limp wallpaper. Finally, the device is sized to easily fit into the user's pocket, or it may include a hanger hole 22 for temporarily storing the device when not in use.

It is recognized that changes, variations and changes may be made to the wallpaper hanging device of this invention, especially by those skilled in the art, without departing from the spirit and scope thereof Accordingly, no limitation is intended to be imposed thereon except as set forth in the following claims.

1. A wallpaper hanging device for applying a tangential wiping force to freshly applied wallpaper to remove excessive adhesive and air bubbles from said freshly applied wallpaper, said device comprising a generally rectangular, thin curved body portion having a pair of parallel wiping edges and a pair of curved edges extending therebetween.

2. The wallpaper hanging device according to claim 1, wherein said curved body portion is fabricated of a thin walled polyurethane.

3. The wallpaper hanging device according to claim 1, wherein said curved body portion includes an embossed center portion spaced inwardly from said respective edges.

4. The wallpaper hanging device according to claim 1, wherein said curved body portion includes a through aperture for use in storing said device during periods of nonuse.

5. The wallpaper hanging device according to claim 1, wherein said parallel edges are about ten inches, and said curved edges are about four inches, where said curved edges have a radius of about 5½ inches.

6. The wallpaper hanging device according to claim 1, wherein the curved shape of the body portion allows for the outer surface of said body portion to cooperatively wipe with a respective said parallel edge to remove excessive adhesive and air bubbles from beneath said fresh wallpaper.
